(19) United States
(12) Patent Application Publication
(10) Pub. No.: US 2021/0261890 A1
(43) Pub. Date: Aug. 26, 2021

(54) LIQUID ELECTROPHOTOGRAPHIC PRINTER CLEANING METHODS AND CLEANING COMPOSITIONS

(71) Applicant: HEWLETT-PACKARD DEVELOPMENT COMPANY, L.P., Spring, TX (US)

(72) Inventors: Eyal Bachar, Nes Ziona (IL); Vladislav Kaploun, Nes Ziona (IL)

(21) Appl. No.: 16/605,262

(22) PCT Filed: Jun. 18, 2018
(86) PCT No.: PCT/US2018/038031

§ 371 Date: Oct. 15, 2019

(51) Int. Cl. C11D 11/00; C11D 3/37; C11D 3/43; C11D 3/20; C11D 1/14; C11D 17/00; G03G 15/11; G03G 21/00

(52) U.S. Cl. CPC C11D 11/0047; C11D 3/3765; C11D 3/43; G03G 21/0088; C11D 1/143; C11D 17/0004; G03G 15/11; C11D 3/2079

(57) ABSTRACT

Described herein are methods of cleaning liquid electrophotographic printers and liquid electrophotographic cleaning compositions for use in such methods. The cleaning compositions comprise a resin and a charge director dispersed in a carrier liquid. The cleaning compositions comprise from about 3 wt. % to about 6 wt. % non-volatile solids (NVS). The methods comprise flushing upstream ink feed components of the liquid electrophotographic printer with the cleaning compositions.

### BACKGROUND

Electrophotographic printing processes typically involve creating an image on a photoconductive surface, applying an ink having charged particles to the photoconductive surface, such that they selectively bind to the image, and then transferring the charged particles in the form of the image to a print substrate.

The photoconductive surface is typically on a cylinder and is often termed a photo imaging plate (PIP). The photoconductive surface is selectively charged with a latent electrostatic image having image and background areas with different potentials. For example, an electrophotographic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate.

### BRIEF DESCRIPTION OF THE FIGURES

FIG. 1 shows a schematic illustration of an example of a liquid electrophotographic printing apparatus;

FIG. 2 shows a schematic illustration of upstream ink feed components of an example of a liquid electrophotographic printing apparatus;

FIG. 3 shows a schematic illustration of cleaning composition being flushed through upstream ink feed components of an example of a liquid electrophotographic printing apparatus;

FIG. 4 shows a schematic illustration of carrier liquid being flushed through upstream ink feed components of an example of a liquid electrophotographic printing apparatus;

FIG. 5 shows a schematic illustration of carrier liquid being flushed through upstream ink feed components of an example of a liquid electrophotographic printing apparatus;

FIG. 6 shows an alternative schematic illustration of carrier liquid being flushed through upstream ink feed components of an example of a liquid electrophotographic printing apparatus;

FIG. 7 illustrates an example method of cleaning a liquid electrophotographic printer;

FIG. 8 illustrates an alternative example method of cleaning a liquid electrophotographic printer; and

FIG. 9 illustrates a further alternative example method of cleaning a liquid electrophotographic printer.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, resin, charge directors and other additives can be dispersed to form a liquid electrophotographic ink composition or liquid electrophotographic printer cleaning composition. The carrier liquids may include a mixture of a variety of different agents, such as surfactants, co-solvents, viscosity modifiers, and/or other possible ingredients.

As used herein, “electrostatic ink composition” or “electrophotographic ink composition” or “liquid electrostatic ink composition” or “liquid electrophotographic ink composition” generally refers to an ink composition that is typically suitable for use in an electrostatic printing process, sometimes termed an electrophotographic printing process. It may comprise pigment particles, which may comprise a thermoplastic resin, for example, the pigment particles may have thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “cleaning composition” or “liquid electrostatic cleaning composition” or “liquid electrophotographic cleaning composition” generally refers to a cleaning composition that is typically suitable for use in cleaning upstream ink feed components of a liquid electrophotographic printer. The cleaning composition may be a liquid cleaning composition in which resin particles are suspended in a carrier liquid. The resin particles will typically be charged or capable of developing charge in an electric field, such that they display electrophoretic behaviour. A charge director may be present to impart a charge to the resin particles.

As used herein, “copolymer” refers to a polymer that is polymerized from at least two monomers. A certain monomer may be described herein as constituting a certain weight percentage of a polymer. This indicates that the repeating units formed from the said monomer in the polymer constitute said weight percentage of the polymer.

As used herein, “melt flow rate” generally refers to the extrusion rate of a resin through an orifice of defined dimensions at a specified temperature and load, usually reported as temperature/load, e.g. 190° C/2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrophotographic ink composition or liquid electrophotographic printer cleaning composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition or liquid electrophotographic printer cleaning composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition or liquid electrophotographic printer cleaning composition.

If a standard test is mentioned herein, unless otherwise stated, the version of the test to be referred to is the most recent at the time of filing this patent application.

As used herein, “electrostatic printing” or “electrophotographic printing” generally refers to the process that provides an image that is transferred from a photo imaging substrate either directly or indirectly via an intermediate transfer member to a print substrate, such as a paper substrate or plastic film. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrostatic printing” or “liquid electrophotographic printing” is a specific type of electrostatic printing in which a liquid composition is employed in the electrophotographic process rather than a powder toner. An electrostatic or electrophotographic printing process may involve subjecting the electrostatic composition to an electric field, for example, an electric field having a field gradient of 50-400 V/μm, or more, in some examples, 600-900 V/μm, or more, in some examples 1000 V/cm or more, or in some examples 1500 V/cm or more.

As used herein, “low field conductivity” refers to the electrical conductivity of a liquid electrophotographic printer cleaning composition and is measured by applying a constant amplitude AC voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The present low field conductivities were measured at the following conditions: electrical field amplitude: 5-15 V/mm, frequency: 5-15 Hz, and temperature: 23+/−2 C.

As used herein, “high field conductivity” refers to the maximum electrical conductivity of the liquid electrophotographic printer cleaning composition measured at the following conditions: electrical field pulse—shape: rectangular; height: 1500 V/mm; duration: 8 sec, rise time: 1 ms or less; ripple: 10 V/mm or less; sampling frequency: 1000 per second; and temperature: 23+/−2 C.

As used herein, “direct conductivity” refers to the average conductivity of the liquid electrophotographic printer cleaning composition measured between 6.4 and 7.2 seconds and was measured by applying a constant high voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The conductivity of the liquid electrophotographic printer cleaning composition measured in constant electrical field is varying (actually declining) with time. As such, the maximum value of the conductivity is defined as the “high field conductivity” as noted above, and the “direct conductivity” is the conductivity at the tail of the conductivity vs. time curve when the conductivity has levelled off.

As used herein, “particle conductivity” refers to the difference between the high field conductivity and the low field conductivity as defined above. The particle conductivity is proportional to the particle properties; i.e., mobility and electrical charge created on the particles.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in a composition, and not including the weight of any carrier fluid present.

Unless otherwise stated, any feature described herein can be combined with any aspect or any other feature described herein.

In an aspect, there is provided a method of cleaning a liquid electrophotographic printer comprising flushing upstream ink feed components of the liquid electrophotographic printer with a cleaning composition comprising a resin and a charge director dispersed in a carrier liquid, wherein the cleaning composition comprises from about 3 wt. % to about 6 wt. % non-volatile solids (NVS).

In another aspect, there is provided a liquid electrophotographic printer cleaning composition comprising a carrier liquid; a resin; and a charge director; wherein the cleaning composition comprises from about 3 wt. % to about 6 wt. % non-volatile solids (NVS).

After a liquid electrophotographic printing process using a first electrophotographic ink in liquid electrophotographic printer has been completed, residue of the first ink may remain on upstream ink feed components of the liquid electrophotographic printer. Unless the ink residue is removed, ink contamination may occur when the same upstream ink feed components are subsequently used to print a second electrophotographic ink. This is particularly evident where the first ink is a pigmented ink and the second ink is a transparent ink. Some ink residue may be removed by flushing upstream ink feed components with carrier liquid. However, flushing of upstream ink feed components with carrier liquid alone is time-consuming and may not be sufficient to remove all ink residue without numerous flushing cycles.

The present inventors have found that examples of the processes and products as described herein avoid or at least mitigate at least one of the difficulties described above. They have found that examples of the processes and products described herein enable sufficient cleaning of ink residue from upstream ink feed components such that sequential electrophotographic printing using different electrophotographic inks is made possible with reduced risk of ink contamination and with reduced ink changeover time.

Cleaning Composition

The cleaning composition comprises a resin, a charge director and a carrier liquid and from about 3 wt. % to about 6 wt. % non-volatile solids (NVS). The resin and the charge director may be dispersed in the carrier liquid. The resin may be present in the cleaning composition as resin particles dispersed in the carrier liquid. In some examples, the cleaning composition comprises more than one charge director. In some examples, the cleaning composition comprises a charge adjuvant and/or a grinding aid.

Resin

The resin may be a polymer resin. The resin may be a thermoplastic resin. The resin may be referred to as a thermoplastic polymer.

In some examples, the resin comprises a polymer having acidic side groups. In some examples, the resin comprises a copolymer of an alkylene monomer and a monomer selected from acrylic acid and methacrylic acid.

In some examples, the resin comprises a copolymer of an alkylene monomer selected from ethylene and propylene and a monomer selected from acrylic acid and methacrylic acid.

In some examples, the resin comprises: ethylene or propylene acrylic acid copolymers; ethylene or propylene methacrylic acid copolymers; ethylene vinyl acetate copolymers; copolymers of ethylene or propylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20.0 wt. %) and alkyl (e.g. C1 to C5) ester of methacrylic or acrylic acid (e.g. 0.1 wt. % to 20 wt. %); copolymers of ethylene or propylene (e.g. 70 wt. % to 99.9 wt. %) and maleic anhydride (e.g. 0.1 wt. % to 30 wt. %); polyethylene; polystyrene; isotactic polypropylene (crystalline); copolymers of ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers or combinations thereof.

The resin may comprise a polymer having acidic side groups which has an acidity of about 50 mg KOH/g or more, in some examples, an acidity of about 60 mg KOH/g or more, in some examples, an acidity of about 70 mg KOH/g or more, in some examples, an acidity of about 80 mg KOH/g or more, in some examples, an acidity of about 90 mg KOH/g or more, in some examples, an acidity of about 100 mg KOH/g or more, in some examples, an acidity of about 105 mg KOH/g or more, in some examples, about 110 mg KOH/g or more, in some examples, about 115 mg KOH/g or more. The polymer having acidic side groups may have an acidity of about 200 mg KOH/g or less, in some examples, about 190 mg or less, in some examples, about 180 mg or less, in some examples, about 130 mg KOH/g or less, in some examples, about 120 mg KOH/g or less. The polymer having acidic side groups may have an acidity of from about 50 mg KOH/g to about 200 mg KOH/g, for example, from about 60 mg KOH/g to about 190 mg KOH/g, or from about 70 mg KOH/g to about 180 mg KOH/g, or from about 80 mg KOH/g to about 170 mg KOH/g, or from about 90 mg KOH/g to about 160 mg KOH/g, or from about 100 mg KOH/g to about 160 mg KOH/g. Acidity of a polymer, as measured in mg KOH/g, can be measured using standard procedures, for example, using the procedure described in ASTM D1386.

The resin may comprise a polymer having acidic side groups and a melt flow rate of about 70 g/10 minutes or less, in some examples, about 60 g/10 minutes or less, in some examples, about 50 g/10 minutes or less, in some examples, about 40 g/10 minutes or less, in some examples, 30 g/10 minutes or less, in some examples, 20 g/10 minutes or less, in some examples, 10 g/10 minutes or less. In some examples, all polymers having acidic side groups and/or ester groups in the particles each individually have a melt flow rate of less than 90 g/10 minutes, 80 g/10 minutes or less, in some examples, 70 g/10 minutes or less, in some examples, 60 g/10 minutes or less.

The polymer having acidic side groups can have a melt flow rate of about 10 g/10 minutes to about 120 g/10 minutes, in some examples, about 10 g/10 minutes to about 70 g/10 minutes, in some examples, about 10 g/10 minutes to 40 g/10 minutes, in some examples, 20 g/10 minutes to 30 g/10 minutes. The polymer having acidic side groups can have a melt flow rate of, in some examples, about 50 g/10 minutes to about 120 g/10 minutes, in some examples, 60 g/10 minutes to about 100 g/10 minutes. The melt flow rate can be measured using standard procedures, for example, as described in ASTM D1238.

The acidic side groups may be in free acid form or may be in the form of an anion and associated with a counterion, generally metal counterions, for example, a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitutes from about 5 wt. % to about 25 wt. % of the copolymer, in some examples, from about 10 wt. % to about 20 wt. % of the copolymer.

The resin may comprise two different polymers, for example, two different polymers selected from the polymers described above. The resin may comprise a first polymer and a second polymer, wherein the ratio of the first polymer to the second polymer can be from about 10:1 to about 2:1, for example, from about 6:1 to about 3:1, for example, about 4:1.

The resin may comprise two different polymers having acidic side groups. The two polymers having acidic side groups may have different acidities, which may fall within the ranges mentioned above. The resin may comprise a first polymer having acidic side groups which has an acidity of from about 10 mg KOH/g to about 110 mg

KOH/g, in some examples, about 20 mg KOH/g to about 110 mg KOH/g, in some examples, about 30 mg KOH/g to about 110 mg KOH/g, in some examples, about 50 mg KOH/g to about 110 mg KOH/g, and a second polymer having acidic side groups that has an acidity of about 110 mg KOH/g to about 130 mg KOH/g.

The resin may comprise two different polymers having acidic side groups: a first polymer having acidic side groups that has a melt flow rate of about 10 g/10 minutes to about 50 g/10 minutes and an acidity of from about 10 mg KOH/g to about 110 mg KOH/g, in some examples, about 20 mg KOH/g to about 110 mg KOH/g, in some examples, about 30 mg KOH/g to about 110 mg KOH/g, in some examples, about 50 mg KOH/g to about 110 mg KOH/g, and a second polymer having acidic side groups that has a melt flow rate of about 50 g/10 minutes to about 120 g/10 minutes and an acidity of about 110 mg KOH/g to about 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples, about 4:1.

The resin may comprise a polymer having a melt viscosity of about 15000 poise or less, in some examples, a melt viscosity of about 10000 poise or less, in some examples, about 1000 poise or less, in some examples, 100 poise or less, in some examples, about 50 poise or less, in some examples, about 10 poise or less; said polymer may be a polymer having acidic side groups as described herein. The resin may comprise a first polymer having a melt viscosity of about 15000 poise or more, in some examples, about 20000 poise or more, in some examples, about 50000 poise or more, in some examples, about 70000 poise or more; and in some examples, the resin may comprise a second polymer having a melt viscosity less than the first polymer, in some examples, a melt viscosity of about 15000 poise or less, in some examples, a melt viscosity of about 10000 poise or less, in some examples, about 1000 poise or less, in some examples, about 100 poise or less, in some examples, about 50 poise or less, in some examples, about 10 poise or less. The resin may comprise a first polymer having a melt viscosity of more than about 60000 poise, in some examples, from about 60000 poise to about 100000 poise, in some examples, from about 65000 poise to about 85000 poise; a second polymer having a melt viscosity of from about 15000 poise to about 40000 poise, in some examples, about 20000 poise to about 30000 poise, and a third polymer having a melt viscosity of about 15000 poise or less, in some examples, a melt viscosity of about 10000 poise or less, in some examples, about 1000 poise or less, in some examples, about 100 poise or less, in some examples, about 50 poise or less, in some examples, about 10 poise or less. An example of the first polymer is Nucrel 960 (from DuPont), and example of the second polymer is Nucrel 699 (from DuPont), and an example of the third polymer is AC-5120 or AC-5180 (from Honeywell). The resin may comprise a first polymer having a melt viscosity of from about 15000 poise to about 40000 poise, in some examples, about 20000 poise to about 30000 poise, and a second polymer having a melt viscosity of about 15000 poise or less, in some examples, a melt viscosity of about 10000 poise or less, in some examples, about 1000 poise or less, in some examples, about 100 poise or less, in some examples, about 50 poise or less, in some examples, about 10 poise or less. An example of the first polymer is Nucrel 699 (from DuPont), and an example of the second polymer is AC-5120 or AC-5180 (from Honeywell). The first, second and/or third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of polymer, the polymer (excluding any other components of the cleaning composition) may have a melt viscosity of about 6000 poise or more, in some examples, a melt viscosity of about 8000 poise or more, in some examples, a melt viscosity of about 10000 poise or more, in some examples, a melt viscosity of about 12000 poise or more. If the resin comprises a plurality of polymers all the polymers of the resin may together form a mixture (excluding any other components of the cleaning composition) that has a melt viscosity of about 6000 poise or more, in some examples, a melt viscosity of about 8000 poise or more, in some examples, a melt viscosity of about 10000 poise or more, in some examples, a melt viscosity of about 12000 poise or more. Melt viscosity can be measured using standard techniques. The melt viscosity can be measured using a rheometer, for example, a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either acrylic acid or methacrylic acid; or ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid or methacrylic acid, wherein the ethylenically unsaturated acid of either acrylic or methacrylic acid constitutes from about 8 wt. % to about 16 wt. % of the copolymer, in some examples, about 10 wt. % to about 12 wt. % of the copolymer; and (ii) a second polymer that is a copolymer of ethylene and an ethylenically unsaturated acid of either acrylic acid or methacrylic acid, wherein the ethylenically unsaturated acid of either acrylic or methacrylic acid constitutes from about 10 wt. % to about 30 wt. % of the copolymer, in some examples, from about 12 wt. % to about 20 wt. % of the copolymer, in some examples, from about 14 wt. % to about 19 wt. % of the copolymer in some examples, from about 14 wt. % to about 17 wt. % of the copolymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, for example, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbon atoms, in some examples, 1 to 20 carbon atoms, in some examples, 1 to 10 carbon atoms; in some examples, selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples, an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute about 1% to about 50% by weight of the copolymer, in some examples, about 5% to about 40% by weight, in some examples, about 5% to about 20% by weight of the copolymer, in some examples, about 5% to about 15% by weight of the copolymer. The second monomer may constitute about 1% to about 50% by weight of the copolymer, in some examples, about 5% to about 40% by weight of the copolymer, in some examples, about 5% to about 20% by weight of the copolymer, in some examples, about 5% to about 15% by weight of the copolymer. In some examples, the first monomer constitutes about 5% to about 40% by weight of the copolymer and the second monomer constitutes about 5% to about 40% by weight of the copolymer, with the third monomer constituting the remaining weight of the copolymer. In some examples, the first monomer constitutes about 5% to about 15% by weight of the copolymer and the second monomer constitutes about 5% to about 15% by weight of the copolymer, with the third monomer constituting the remaining weight of the copolymer. In some examples, the first monomer constitutes about 8% to about 12% by weight of the copolymer and the second monomer constitutes about 8% to about 12% by weight of the copolymer, with the third monomer constituting the remaining weight of the copolymer. In some examples, the first monomer constitutes about 10% by weight of the copolymer and the second monomer constitutes about 10% by weight of the copolymer, with the third monomer constituting the remaining weight of the copolymer. The polymer may be selected from the Bynel® class of monomer, including Bynel 2022 and Bynel 2002, which are available from DuPont®.

The polymer having ester side groups may constitute about 1% or more by weight of the total amount of the resin polymers, e.g. first thermoplastic resin polymers, in the cleaning composition. The polymer having ester side groups may constitute about 5% or more by weight of the total amount of the resin polymers, e.g. first thermoplastic resin polymers, in some examples, about 8% or more by weight of the total amount of the resin polymers, e.g. first thermoplastic resin polymers, in some examples, about 10% or more by weight of the total amount of the resin polymers, e.g. first thermoplastic resin polymers, in some examples, about 15% or more by weight of the total amount of the resin polymers, e.g. first thermoplastic resin polymers, in some examples, about 20% or more by weight of the total amount of the resin polymers, e.g. first thermoplastic resin polymers, in some examples, about 25% or more by weight of the total amount of the resin polymers, e.g. first thermoplastic resin polymers, in some examples, about 30% or more by weight of the total amount of the resin polymers, e.g. first thermoplastic resin polymers, in some examples, about 35% or more by weight of the total amount of the resin polymers, e.g. first thermoplastic resin polymers, in the cleaning composition. The polymer having ester side groups may constitute from about 5% to about 50% by weight of the total amount of the resin polymers, e.g. first thermoplastic resin polymers, in the cleaning composition, in some examples, about 10% to about 40% by weight of the total amount of the resin polymers, e.g. first thermoplastic resin polymers, in the cleaning composition, in some examples, about 5% to about 30% by weight of the total amount of the resin polymers, e.g. first thermoplastic resin polymers, in the cleaning composition, in some examples, about 5% to about 15% by weight of the total amount of the resin polymers, e.g. first thermoplastic resin polymers, in the cleaning composition, in some examples, about 15% to about 30% by weight of the total amount of the resin polymers, e.g. first thermoplastic resin polymers, in the cleaning composition.

The polymer having ester side groups may have an acidity of about 50 mg KOH/g or more, in some examples, an acidity of about 60 mg KOH/g or more, in some examples, an acidity of about 70 mg KOH/g or more, in some examples, an acidity of about 80 mg KOH/g or more. The polymer having ester side groups may have an acidity of about 100 mg KOH/g or less, in some examples, about 90 mg KOH/g or less. The polymer having ester side groups may have an acidity of about 60 mg KOH/g to about 90 mg KOH/g, in some examples, about 70 mg KOH/g to about 80 mg KOH/g.

The polymer having ester side groups may have a melt flow rate of about 10 g/10 minutes to about 120 g/10 minutes, in some examples, about 10 g/10 minutes to about 50 g/10 minutes, in some examples, about 20 g/10 minutes to about 40 g/10 minutes, in some examples, about 25 g/10 minutes to about 35 g/10 minutes.

The polymer, polymers, copolymer or copolymers of the resin (e.g. the first or second thermoplastic resins) can, in some examples, be selected from the Nucrel family of resins (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the AC family of resins (e.g. AC-5120, AC-5180, AC-540, AC-580 (sold by Honeywell)), the Aclyn family of resins (e.g. Aclyn 201, Aclyn 246, Aclyn 285, and Aclyn 295), and the Lotader family of resins (e.g. Lotader 2210, Lotader, 3430, and Lotader 8200 (sold by Arkema)).

Charge Director

A charge director is added to the cleaning composition to impart a charge of a desired polarity and/or maintain sufficient electrostatic charge on the resin particles in the cleaning composition and/or on resin particles in ink residue removed from upstream ink feed components on cleaning with the cleaning composition. The charge director may be added to the cleaning composition in an amount greater than required to impart a charge of a desired polarity and/or maintain sufficient electrostatic charge on the resin particles in the cleaning composition prior to use of the cleaning composition in a liquid electrophotographic printer. For example, the charge director may be added to the cleaning composition in an excess amount. The charge director may be added to the cleaning composition in an excess amount which is at least 5%, for example, at least 10%, or at least 25%, or at least 50%, or at least 75%, or at least 100%, greater than the amount of charge director required to disperse and adequately charge the resin particles in the cleaning composition prior to use of the cleaning composition in a liquid electrophotographic printer.

The charge director may comprise ionic compounds, including, for example, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, for example, barium, sodium, calcium, and aluminium salts of sulfonic acid. The sulfonic acids may include, for example, alkyl sulfonic acids, aryl sulfonic acids, and sulfonic acids of alkyl succinates (e.g. see WO 2007/130069). The charge director can impart a negative charge or a positive charge on the resin-containing particles.

The charge director can comprise a sulfosuccinate moiety of the general formula: [Rₐ—O—C(O)CH₂CH(SO₃⁻)C(O)—O—R_{b}], where each of Rₐ and R_{b} is an alkyl group. In some examples, the charge director comprises nanoparticles of a simple salt and a sulfosuccinate salt of the general formula MAₙ, wherein M is a metal, n is the valence of M, and A is an ion of the general formula [Rₐ—O—C(O)CH₂CH(SO₃⁻)C(O)—O—R_{b}], where each of Rₐ and R_{b} is an alkyl group, or other charge directors as found in WO2007130069, which is incorporated herein by reference in its entirety. As described in WO2007130069, the sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 200 nm or less, in some examples, 2 nm or more. As described in WO2007130069, simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al³⁺, or from any sub-group thereof. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof. The charge director may further comprise Basic Barium Petronate® (BBP).

In the formula [Rₐ—O—C(O)CH₂CH(SO₃⁻)C(O)—O—R_{b}], in some examples, each of Rₐ and R_{b} is an aliphatic alkyl group. In some examples, each of Rₐ and R_{b} independently is a C₆₋₂₅ alkyl. In some examples, said aliphatic alkyl group is linear.

In some examples, said aliphatic alkyl group is branched. In some examples, said aliphatic alkyl group includes a linear chain of more than 6 carbon atoms. In some examples, Rₐ and R_{b} are the same. In some examples, at least one of Rₐ and R_{b} is C₁₃H₂₇. In some examples, M is Na, K, Cs, Ca, or Ba. The formula [Rₐ—O—C(O)CH₂CH(SO₃)C(O)—O—R_{b}] and/or the formula MA, may be as defined in any part of WO2007130069.

The charge director may be a natural charge director (NCD), for example, a natural charge director which comprises (i) natural soya lecithin, (ii) a barium sulfonate salt, such as Basic Barium Petronate® (BBP), and (iii) an isopropyl amine sulfonate salt.

It may be that each of components (i), (ii) and (iii) are provided in weight ratios of 6.6%:9.8%:3.6%.

Basic Barium Petronate® is a barium sulfonate salt of a 21-26 hydrocarbon alkyl, and can be obtained, for example, from Chemtura.

An example isopropyl amine sulfonate salt is dodecyl benzene sulfonic acid isopropyl amine, which is available from Croda.

The charge director may constitute no less than about 0.001%, for example, no less than about 0.01%, or no less than about 0.1%, or no less than about 0.2%, or no less than about 0.4%, or no less than about 0.6%, or no less than about 0.8%, or no less than about 1.0%, or no less than about 1.2%, or no less than about 1.4%, or no less than about 1.6%, or no less than about 1.8%, or no less than about 2.0%, or no less than about 2.2%, or no less than about 2.4%, or no less than about 2.6%, or no less than about 2.8%, or no less than about 3.0%, or no less than about 3.2%, or no less than about 3.4%, or no less than about 3.6%, or no less than about 3.8%, or no less than about 4.0%, or no less than about 4.2%, or no less than about 4.4%, by weight of the solids in the cleaning composition.

The charge director may constitute no more than about 30%, for example, no more than about 25%, or no more than about 20%, or no more than about 15%, or no more than about 10%, or no more than about 9%, or no more than about 8%, or no more than about 7%, or no more than about 6%, or no more than about 5%, or no more than about 4%, or no more than about 3%, or no more than about 2%, by weight or no more than about 1%, of the solids in the cleaning composition.

The charge director may constitute from about 0.001% to about 30%, for example, from about 0.001% to about 25%, or from about 0.001% to about 20%, or from about 0.001% to about 15%, or from about 0.001% to about 10%, or from about 0.001% to about 9%, or from about 0.001% to about 8%, or from about 0.001 to about 7%, or from about 0.001% to about 6%, or from about 0.001% to about 5%, or from about 0.001% to about 4%, or from about 0.001% to about 3%, or from about 0.001% to about 2%, or from about 0.001% to about 1%, by weight of the solids in the cleaning composition.

The charge director may constitute from about 0.01% to about 30%, for example, from about 0.01% to about 25%, or from about 0.01% to about 20%, or from about 0.01% to about 15%, or from about 0.01% to about 10%, or from about 0.01% to about 9%, or from about 0.01% to about 8%, or from about 0.01% to about 7%, or from about 0.01% to about 6%, or from about 0.01% to about 5%, or from about 0.01% to about 4%, or from about 0.01% to about 3%, or from about 0.01% to about 2%, or from about 0.01% to about 1%, by weight of the solids in the cleaning composition.

The charge director may constitute from about 0.1% to about 30%, for example, from about 0.1% to about 25%, or from about 0.1% to about 20%, or from about 0.1% to about 15%, or from about 0.1% to about 10%, or from about 0.1% to about 9%, or from about 0.1% to about 8%, or from about 0.1% to about 7%, or from about 0.1% to about 6%, or from about 0.1% to about 5%, or from about 0.1 to about 4%, or from about 0.1% to about 3%, or from about 0.1% to about 2%, or from about 0.1% to about 1%, by weight of the solids in the cleaning composition.

The charge director may constitute from about 0.2% to about 10%, for example, from about 0.4% to about 9%, or from about 0.6% to about 8%, or from about 0.8 to about 7%, or from about 0.8% to about 6%, or from about 1.0% to about 6%, or from about 1.2% to about 6%, or from about 1.4% to about 6%, or from about 1.6% to about 6%, or from about 1.8% to about 6%, or from about 2.0% to about 6%, or from about 2.2% to about 6%, or from about 2.4% to about 6%, or from about 2.6% to about 6%, or from about 2.8% to about 6%, or from about 3.0 to about 6%, or from about 3.2% to about 6%, or from about 3.4% to about 6%, or from about 3.6% to about 6%, or from about 3.8% to about 6%, or from about 4% to about 6%, or from about 4% to about 5%, by weight of the solids in the cleaning composition.

In some examples, the cleaning composition comprises no less than about 0.01 mg, for example, no less than about 0.1 mg, or no less than about 0.5 mg, or no less than about 1 mg, or no less than about 5 mg, or no less than about 10 mg, or no less than about 15 mg, or no less than about 20 mg, or no less than about 25 mg, or no less than about 30 mg, or no less than about 35 mg, or no less than about 40 mg, or no less than about 45 mg, of charge director per gram of solids.

In some examples, the cleaning composition comprises no more than about 100 mg, for example, no more than about 90 mg, or no more than about 80 mg, or no more than about 70 mg, or no more than about 60 mg, or no more than about 50 mg, or no more than about 45 mg, or no more than about 40 mg, or no more than about 35 mg, or no more than about 30 mg, or no more than about 25 mg, or no more than about 20 mg, or no more than about 15 mg, or no more than about 10 mg, of charge director per gram of solids.

In some examples, the cleaning composition comprises from about 0.01 mg to about 100 mg, for example, from about 0.1 mg to about 80 mg, or from about 0.5 mg to about 70 mg, or from about 1 mg to about 60 mg, or from about 1 mg to about 50 mg, or from about 1 mg to about 45 mg, or from about 5 mg to about 45 mg, or from about 5 mg to about 40 mg, or from about 5 mg to about 35 mg, or from about 5 mg to about 30 mg, or from about 5 mg to about 25 mg, or from about 5 mg to about 20 mg, or from about 5 mg to about 15 mg, or from about 5 mg to about 10 mg, or from about 10 mg, to about 60 mg, or from about 15 mg to about 60 mg, or from about 20 mg to about 60 mg, or from about 30 mg to about 60 mg, or from about 35 mg to about 55 mg, or from about 40 mg to about 50 mg, of charge director per gram of solids.

In some examples, a charge director imparts a negative charge on the cleaning composition. The particle conductivity may range from 50 to 500 μmho/cm, in some examples, from 200-350 μmho/cm.

In some examples, the cleaning composition comprises more than one charge director. In some examples, the cleaning composition comprises two charge directors. In some examples, the cleaning composition comprises an oil-soluble petroleum sulfonate, for example, Basic Barium Petronate®, and a natural charge director (NCD), for example, a natural charge director which comprises (i) natural soya lecithin, (ii) a barium sulfonate salt, such as basic Barium Petronate® (BBP), and (iii) an isopropyl amine sulfonate salt.

In some examples, oil-soluble petroleum sulfonate, for example, Basic Barium Petronate®, may constitute no less than about 0.001%, for example, no less than about 0.01%, or no less than about 0.1%, or no less than about 0.2%, or no less than about 0.4%, or no less than about 0.6%, or no less than about 0.8%, or no less than about 1.0%, or no less than about 1.2%, or no less than about 1.4%, or no less than about 1.6%, or no less than about 1.8%, or no less than about 2.0%, or no less than about 2.2%, or no less than about 2.4%, or no less than about 2.6%, or no less than about 2.8%, or no less than about 3.0%, or no less than about 3.2%, or no less than about 3.4%, or no less than about 3.6%, or no less than about 3.8%, or no less than about 4.0%, or no less than about 4.2%, or no less than about 4.4%, by weight of the solids in the cleaning composition.

In some examples, oil-soluble petroleum sulfonate, for example, Basic Barium Petronate®, may constitute no more than about 30%, for example, no more than about 25%, or no more than about 20%, or no more than about 15%, or no more than about 10%, or no more than about 9%, or no more than about 8%, or no more than about 7%, or no more than about 6%, or no more than about 5%, or no more than about 4%, or no more than about 3%, or no more than about 2%, or no more than about 1%, by weight of the solids in the cleaning composition.

In some examples, oil-soluble petroleum sulfonate, for example, Basic Barium Petronate®, may constitute from about 0.001% to about 30%, for example, from about 0.001% to about 25%, or from about 0.001% to about 20%, or from about 0.001% to about 15%, or from about 0.001% to about 10%, or from about 0.001 to about 9%, or from about 0.001% to about 8%, or from about 0.001% to about 7%, or from about 0.001% to about 6%, or from about 0.001% to about 5%, or from about 0.001% to about 4%, or from about 0.001% to about 3%, or from about 0.001% to about 2%, or from about 0.001% to about 1%, by weight of the solids in the cleaning composition.

In some examples, oil-soluble petroleum sulfonate, for example, Basic Barium Petronate®, may constitute from about 0.01% to about 30%, for example, from about 0.01% to about 25%, or from about 0.01% to about 20%, or from about 0.01% to about 15%, or from about 0.01% to about 10%, or from about 0.01% to about 9%, or from about 0.01% to about 8%, or from about 0.01% to about 7%, or from about 0.01% to about 6%, or from about 0.01% to about 5%, or from about 0.01% to about 4%, or from about 0.01% to about 3%, or from about 0.01% to about 2%, or from about 0.01% to about 1%, by weight of the solids in the cleaning composition.

In some examples, oil-soluble petroleum sulfonate, for example, Basic Barium Petronate®, may constitute from about 0.1% to about 30%, for example, from about 0.1% to about 25%, or from about 0.1% to about 20%, or from about 0.1% to about 15%, or from about 0.1% to about 10%, or from about 0.1% to about 9%, or from about 0.1% to about 8%, or from about 0.1% to about 7%, or from about 0.1% to about 6%, or from about 0.1% to about 5%, or from about 0.1% to about 4%, or from about 0.1% to about 3%, or from about 0.1% to about 2%, or from about 0.1% to about 1%, by weight of the solids in the cleaning composition.

In some examples, oil-soluble petroleum sulfonate, for example, Basic Barium Petronate®, may constitute from about 0.2% to about 10%, for example, from about 0.4% to about 9%, or from about 0.6% to about 8%, or from about 0.8% to about 7%, or from about 0.8% to about 6%, or from about 1.0% to about 6%, or from about 1.2% to about 6%, or from about 1.4% to about 6%, or from about 1.6% to about 6%, or from about 1.8% to about 6%, or from about 2.0% to about 6%, or from about 2.2% to about 6%, or from about 2.4% to about 6%, or from about 2.6 to about 6%, or from about 2.8% to about 6%, or from about 3.0% to about 6%, or from about 3.2% to about 6%, or from about 3.4% to about 6%, or from about 3.6% to about 6%, or from about 3.8% to about 6%, or from about 4% to about 6%, or from about 4% to about 5%, by weight of the solids in the cleaning composition.

In some examples, the cleaning composition comprises no less than about 0.01 mg, for example, no less than about 0.1 mg, or no less than about 0.5 mg, or no less than about 1 mg, or no less than about 5 mg, or no less than about 10 mg, or no less than about 15 mg, or no less than about 20 mg, or no less than about 25 mg, or no less than about 30 mg, or no less than about 35 mg, or no less than about 40 mg, or no less than about 45 mg, of oil-soluble petroleum sulfonate, for example, Basic Barium Petronate®, per gram of solids.

In some examples, the cleaning composition comprises no more than about 100 mg, for example, no more than about 90 mg, or no more than about 80 mg, or no more than about 70 mg, or no more than about 60 mg, or no more than about 50 mg, or no more than about 45 mg, or no more than about 40 mg, or no more than about 35 mg, or no more than about 30 mg, or no more than about 25 mg, or no more than about 20 mg, or no more than about 15 mg, or no more than about 10 mg, of oil-soluble petroleum sulfonate, for example, Basic Barium Petronate®, per gram of solids.

In some examples, the cleaning composition comprises from about 0.01 mg to about 100 mg, for example, from about 0.1 mg to about 80 mg, or from about 0.5 mg to about 70 mg, or from about 1 mg to about 60 mg, or from about 1 mg to about 50 mg, or from about 1 mg to about 45 mg, or from about 5 mg to about 45 mg, or from about 5 mg to about 40 mg, or from about 5 mg to about 35 mg, or from about 5 mg to about 30 mg or from about 5 mg to about 25 mg, or from about 5 mg to about 20 mg, or from about 5 mg to about 15 mg, or from about 5 mg to about 10 mg, or from about 10 mg to about 60 mg, or from about 15 mg to about 60 mg, or from about 20 mg to about 60 mg, or from about 30 mg to about 60 mg, or from about 35 mg to about 55 mg, or from about 40 mg to about 50 mg, of oil-soluble petroleum sulfonate, for example, Basic Barium Petronate®, per gram of solids.

In some examples, the cleaning composition comprises no less than about 0.01 mg, for example, no less than about 0.1 mg, or no less than about 0.5 mg, or no less than about 1 mg, or no less than about 5 mg, or no less than about 10 mg, or no less than about 15 mg, or no less than about 20 mg, or no less than about 25 mg, or no less than about 30 mg, or no less than about 35 mg, or no less than about 40 mg, or no less than about 45 mg, of natural charge director per gram of solids.

In some examples, the cleaning composition comprises no more than about 100 mg, for example, no more than about 90 mg, or no more than about 80 mg, or no more than about 70 mg, or no more than about 60 mg, or no more than about 50 mg, or no more than about 45 mg, or no more than about 40 mg, or no more than about 35 mg, or no more than about 30 mg, or no more than about 25 mg, or no more than about 20 mg, or no more than about 15 mg, or no more than about 10 mg, or more than about 8 mg, or no more than about 6 mg, or no more than about 4 mg, or no more than about 2 mg, of natural charge director per gram of solids.

In some examples, the cleaning composition comprises from about 0.01 mg to about 100 mg, for example, from about 0.1 mg to about 80 mg, or from about 0.5 mg to about 70 mg, or from about 1 mg to about 60 mg, or from about 1 mg to about 50 mg, or from about 1mg to about 25 mg, or from about 1 mg to about 10 mg, or from about 1 mg to about 5 mg, or from about 0.5 mg to about 10 mg, or from about 0.5 mg to about 5 mg, or from about 0.1 mg to about 10 mg, or from about 0.1 mg to about 5 mg, of natural charge director per gram of solids.

Carrier Liquid

In some examples, the liquid electrophotographic printer cleaning composition described herein comprises polymer resin particles which are formed in and/or dispersed in the carrier liquid.

Generally, the carrier liquid acts as a dispersing medium both for the components of the cleaning composition and for particles of ink residue dispersed by the cleaning composition in use in a liquid electrophotographic printer.

In some examples, the carrier liquid is a liquid which does not dissolve the resin at room temperature. In some examples, the carrier liquid is a liquid which dissolves the resin at elevated temperatures. For example, the resin may be soluble in the carrier liquid when heated to a temperature of at least 80° C., for example, 90° C., for example, 100° C., for example, 110° C., for example, 120° C. For example, the carrier liquid can comprise or be a hydrocarbon, silicone oil, vegetable oil, etc. The carrier liquid can include an insulating, non-polar, non-aqueous liquid. The carrier liquid can include an insulating, non-polar, non-aqueous liquid suitable for use as a medium for toner particles, i.e. for liquid electrophotographic ink toner particles. The carrier liquid can include compounds that have a resistivity in excess of about 10⁹ ohm·cm.

The carrier liquid may have a dielectric constant below about 5, in some examples, below about 3.

The carrier liquid can include hydrocarbons. The hydrocarbons can include an aliphatic hydrocarbon, an isomerized aliphatic hydrocarbon, branched chain aliphatic hydrocarbons, aromatic hydrocarbons, and combinations thereof. Examples of the carrier liquids include aliphatic hydrocarbons, isoparaffinic compounds, paraffinic compounds, dearomatized hydrocarbon compounds, and the like. In particular, the carrier liquids can include Isopar-G™, Isopar-H™, IsoparL™M, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

The carrier liquid may constitute no less than about 10 wt. %, for example, no less than about 20 wt. %, or no less than about 30 wt. %, or no less than about 40 wt. %, or no less than about 50 wt. %, or no less than about 60 wt. %, or no less than about 70 wt. %, or no less than about 80 wt. %, or no less than about 90 wt. %, or no less than about 91 wt. %, or no less than about 92 wt. %, or no less than about 93 wt. %, or no less than about 94 wt. %, or no less than about 95 wt. %, or no less than about 96 wt. %, or no less than about 97 wt. %, of the cleaning composition. The carrier liquid may constitute no more than about 97 wt. %, for example, no more than about 96 wt. %, or no more than about 95 wt. %, or no more than about 94 wt. %, or no more than about 93 wt. %, or no more than about 92 wt. %, or no more than about 91 wt. %, or no more than about 90 wt. %, of the cleaning composition. The carrier liquid may constitute from about 10 wt. % to about 97 wt. %, for example, from about 50 wt. % to about 97 wt. %, or from about 80 wt. % to about 97 wt. %, or from about 90 wt. % to about 97 wt. %, or from about 91 wt. % to about 97 wt. %, or from about 92 wt. % to about 97 wt. %, or from about 93 wt. % to about 97 wt. %, or from about 94 wt. % to about 97 wt. %, or from about 95 wt. % to about 97 wt. %, or from about 96 wt. % to about 97 wt. %, or from about 94 wt. % to about 96 wt. %, or from about 95 wt. % to about 96 wt. %, or from about 94 wt. % to about 95 wt. %, of the cleaning composition.

Charge Adjuvant

In some examples, the cleaning composition comprises a charge adjuvant. In some examples, the charge adjuvant may also act as a grinding aid. The charge adjuvant may be present with the charge director, and may be different from the charge director. The charge adjuvant may act to increase and/or stabilise the charge on particles, e.g. resin particles or ink residue particles, in the cleaning composition.

The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmitate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium mono- and/or di- and/or tristearate and/or aluminium di- and/or tripalmitate.

The charge adjuvant can constitute about 0.1% to 5% by weight of the solids of a cleaning composition.

Solids

In some examples, the cleaning composition comprises from about 3 wt. % to about 5 wt. %, for example, from about 3 wt. % to about 4 wt. %, or from about 3 wt. % to about 3.5 wt. %, or from about 3.1 wt. % to about 6 wt. %, or from about 3.2 wt. % to about 6 wt. %, or from about 3.3 wt. % to about 6 wt. %, or from about 3.4 wt. % to about 6 wt. %, or from about 3.5 wt. % to about 6 wt. %, or from about 3.7 wt. % to about 6 wt. %, or from about 3.8 wt. % to about 6 wt. %, or from about 3.9 wt. % to about 6 wt. %, or from about 4 wt. % to about 6 wt. %, or from about 3.1 wt. % to about 5 wt. %, or from about 3.2 wt. % to about 5 wt. %, or from about 3.3 wt. % to about 5 wt. %, or from about 3.4 wt. % to about 5 wt. %, or from about 3.5 wt. % to about 5 wt. %, or from about 3.7 wt. % to about 5 wt. %, or from about 3.8 wt. % to about 5 wt. %, or from about 3.9 wt. % to about 5 wt. %, or from about 4 wt. % to about 5 wt. %, of non-volatile solids (NVS).

The weight percentages of non-volatile solids above are the weight percentages of non-volatile solids in the cleaning composition in an in-use form for cleaning a liquid electrophotographic printer, i.e., for flushing through upstream ink feed components of the liquid electrophotographic printer. In some examples, the in-use form of the cleaning composition may be prepared by dilution, for example with carrier liquid, of a more concentrated cleaning composition. Dilution of the concentrated cleaning composition may be required prior to use in the liquid electrophotographic printer, for example, prior to flushing through upstream ink feed components of the liquid electrophotographic printer. In such examples, the weight percentages of non-volatile solids provided above are the weight percentages of non-volatile solids in the cleaning composition following dilution and are not the weight percentages of non-volatile solids in the concentrated cleaning composition.

In some examples, the concentrated cleaning composition comprises no less than about 6 wt. %, for example, no less than about 7 wt. %, or no less than about 8 wt. %, or no less than about 9 wt. %, or no less than about 10 wt. %, or no less than about 11 wt. %, or no less than about 12 wt. %, or no less than about 13 wt. %, or no less than about 14 wt. %, or no less than about 15 wt. %, or no less than about 16 wt. %, or no less than about 17 wt. %, or no less than about 18 wt. %, or no less than about 19 wt. %, or no less than about 20 wt. %, or no less than about 21 wt. %, of non-volatile solids (NVS). In some examples, the concentrated cleaning composition comprises no greater than about 50 wt. %, for example, no greater than about 40 wt. %, or no greater than about 30 wt. %, or no greater than about 29 wt. %, or no greater than about 28 wt. %, or no greater than about 27 wt. %, or no greater than about 26 wt. %, or no greater than about 25 wt. %, or no greater than about 24 wt. %, or no greater than about 23 wt. %, or no greater than about 22 wt. %, of non-volatile solids (NVS). In some examples, the concentrated cleaning composition comprises from about 6 wt. % to about 50 wt. %, for example, from about 6 wt. % to about 40 wt. %, or from about 6 wt. % to about 30 wt. %, or from about 8 wt. % to about 30 wt. %, or from about 10 wt. % to about 30 wt. %, or from about 12 wt. % to about 30 wt. %, or from about 14 wt. % to about 30 wt. %, or from about 16 wt. % to about 30 wt. %, or from about 18 wt. % to about 30 wt. %, or from about 16 wt. % to about 28 wt. %, or from about 16 wt. % to about 26 wt. %, or from about 18 wt. % to about 26 wt. %, or from about 18 wt. % to about 24 wt. %, or from about 20 wt. % to about 24 wt. %, or from about 18 wt. % to about 22 wt. %, or from about 20 wt. % to about 22 wt. %, of non-volatile solids (NVS).

Pigmentation

In some examples, the cleaning composition lacks pigment. In some examples, the cleaning composition lacks pigment particles. In some examples, the cleaning composition is a pigment-free cleaning composition or a substantially pigment-free composition. In some examples, the cleaning composition comprises less than 5 wt. %, for example, less than 3 wt. %, or less than 1 wt. %, of pigment by solids. In some examples, the cleaning composition is colourless. In some examples, the cleaning composition is translucent. In some examples, the cleaning composition is transparent. It will be understood that a transparent cleaning composition is a cleaning composition which is substantially free of pigment or dye.

In some examples, the cleaning composition lacks pigment or pigment particles prior to flushing through upstream ink feed components of the liquid electrophotographic printer. In some examples, in use, the cleaning composition disperses ink residue present on upstream ink feed components of the liquid electrophotographic printer during flushing through the upstream ink feed components, such that the cleaning composition lacks pigment or pigment particles prior to flushing through the upstream ink feed components but comprises pigment or pigment particles during and after flushing through the upstream ink feed components.

In some examples, the cleaning composition comprises pigment. The pigment may be any colorant compatible with the liquid carrier and useful for electrophotographic printing. For example, the pigment may be present as pigment particles, or may comprise a resin (in addition to the polymers described herein) and a pigment. In some examples, the pigment is a white pigment, for example, selected from the group consisting of TiO₂, calcium carbonate, zinc oxide, and mixtures thereof. In some examples, the white pigment particle may comprise an alumina-TiO₂ pigment. In some examples, the pigment particles may have a median particle size or d₅₀ of less than 20 μm, for example, less than 15 μm, for example, less than 10 μm, for example, less than 5 μm, for example, less than 4 μm, for example, less than 3 μm, for example, less than 2 μm, for example, less than 1 μm, for example, less than 0.9 μm, for example, less than 0.8 μm, for example, less than 0.7 μm, for example, less than 0.6 μm, for example, less than 0.5 μm. Unless otherwise stated, the particle size of the pigment particle and the resin coated pigment particle is determined by using laser diffraction on a Malvern Mastersizer 2000 according to the standard procedure as described in the operating manual. The pigment particle may be present in an amount of from 10 wt. % to 80 wt. % of the total amount of resin and pigment, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. % of the total amount of resin and pigment. In some examples, the pigment particle may be present in an amount of at least 50 wt. % of the total amount of resin and pigment, for example, at least 55 wt. % of the total amount of resin and pigment.

Other Additives

In some examples, the cleaning composition may include an additive or a plurality of additives. The additive or plurality of additives may be selected from a surfactant, biocides, organic solvents, viscosity modifiers, materials for pH adjustment, sequestering agents, preservatives, compatibility additives, emulsifiers and the like.

Preparation

In some examples, a method of preparing the cleaning composition comprises mixing or grinding the resin and the charge director with the carrier liquid to form a mixture. The method may comprise diluting the mixture with carrier liquid.

In some examples, the method of preparing the cleaning composition comprises mixing or grinding the resin and the carrier liquid to form a mixture and subsequently mixing the charge director into the mixture. The method may comprise diluting the mixture with carrier liquid.

In some examples, the method of preparing the cleaning composition comprises: mixing or grinding the resin and the carrier liquid to form a mixture; diluting the mixture with carrier liquid; and mixing the charge director into the mixture. The method may comprise further diluting the mixture with carrier liquid.

In some examples, the method of preparing the cleaning composition comprises: mixing or grinding the resin and the carrier liquid to form a concentrated mixture; diluting the concentrated mixture with carrier liquid to form a less concentrated mixture; mixing the charge director into the less concentrated mixture; and diluting the less concentrated mixture with carrier liquid to form the cleaning composition.

In some examples, the method of preparing the cleaning composition comprises: preparing a paste with the resin and the carrier liquid; grinding the paste with carrier liquid to form a mixture; and mixing the charge director into the mixture. The method may further comprise diluting the mixture with carrier liquid. The method may comprise grinding the paste with carrier liquid and the grinding aid and/or charge adjuvant to form the mixture. The paste of the resin and the carrier liquid may be prepared by mixing and/or grinding the resin with the carrier liquid.

In some examples, a Ross mixer is used to mix or grind the resin, carrier liquid, charge director, grinding aid and/or charge adjuvant.

In some examples, the method of preparing the cleaning composition comprises one or more concentration steps. For example, the method may comprise: mixing the resin and the carrier liquid to form a mixture; concentrating the mixture; and mixing the charger director into the mixture. The method may further comprise diluting the mixture with carrier liquid.

In some examples, the method of preparing the cleaning composition comprises: preparing a paste with the resin and the carrier liquid; grinding the paste with carrier liquid, and optionally with the grinding aid and/or charge adjuvant, to form a mixture;

concentrating the mixture; and mixing the charge director into the mixture. The method may further comprise diluting the mixture with carrier liquid.

A vacuum Nutsche filter, such as a Büchner Funnel, may be used to concentrate the paste and/or mixture.

Liquid Electrophotoqraphic Printer

In some examples, a liquid electrophotographic printer comprises at least upstream ink feed components and a photoimaging plate.

In some examples, the upstream ink feed components comprise one or more ink tanks. In some examples, the upstream ink feed components comprise one or more ink developer assemblies. In some embodiments, the upstream ink feed components comprise one or more ink conduits. In some embodiments the upstream ink feed components comprise one or more ink pumps. The one or more ink conduits may connect the ink tanks with the ink developer assemblies. The one or more ink conduits may provide ink flow paths between the ink tanks and the ink developer assemblies. The one or more ink pumps may be operable to drive flow of ink between the ink tanks and the ink developer assemblies through the ink conduits.

In some examples, the photoimaging plate is in the form of a photoconductive drum.

In some example, a liquid electrophotographic printer comprises upstream ink feed components, a photoimaging plate and an intermediate transfer member.

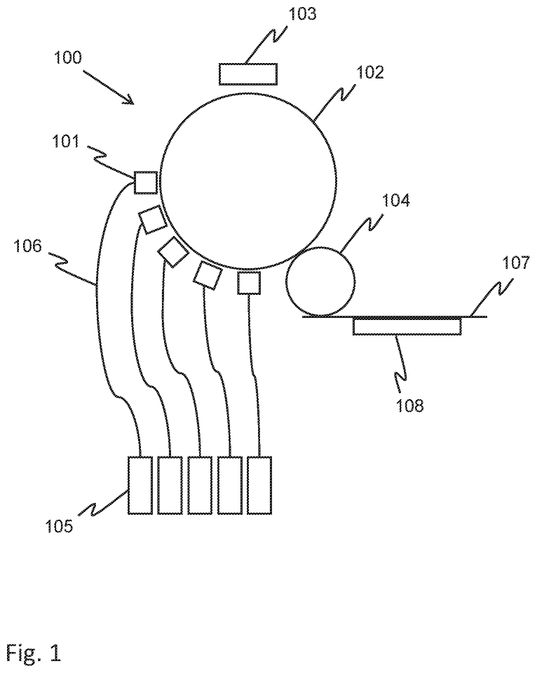

An example of a liquid electrophotographic printer is illustrated schematically in FIG. 1. Liquid electrophotographic printer 100 comprises a plurality of ink developer assemblies 101 arranged around a photoimaging plate in the form of a photoconductive drum 102. A photocharging unit 103 and an intermediate transfer member 104 are provided adjacent the photoconductive drum 102. Each of the ink developer assemblies 101 are connected to ink tanks 105 by ink conduits 106. The ink developer assemblies 101, ink tanks 105 and ink conduits 106 together form upstream ink feed components of the liquid electrophotographic printer.

In use, an image, including any combination of graphics, text and images, may be communicated to the liquid electrographic printer 100. According to an illustrative example, firstly, the photocharging unit 103 deposits a uniform static charge on the photoimaging drum 102 and then a laser imaging portion of the photocharging unit 103 dissipates the static charges in selected portions of the image area on the photoimaging drum 102 to leave a latent electrostatic image. The latent electrostatic image is an electrostatic charge pattern representing the image to be printed. Electrophotographic ink may then transferred to the photoimaging drum 102 by the ink developer assemblies 101 by way of rollers. The ink developer assemblies 101 present a uniform film of electrophotographic ink to the photoimaging drum 102. The electrophotographic ink contains an electrically charged resin component which, by virtue of an appropriate potential on the electrostatic image areas, is attracted to the latent electrostatic image on the photoimaging drum 102. The electrophotographic ink does not adhere to the uncharged, non-image areas and forms an image on the surface of the latent electrostatic image. The photoimaging drum 102 then has a toner image on its surface.

The toner image is then transferred from the photoimaging drum 102 to the intermediate transfer member 104 by virtue of an appropriate potential applied between the photoimaging drum 102 and the intermediate transfer member 104, such that the charged liquid electrophotographic ink is attracted to the intermediate transfer member 104. The image is then dried and fused on the intermediate transfer member 104 before being transferred to a print substrate 107 fed to the intermediate transfer member 104 from a print substrate input station 108.

In some examples, each ink developer assembly 101 is connected to a different tank 105 storing a different electrophotographic ink. For example, each electrophotographic ink may have a different colour (e.g. cyan, magenta, yellow and black). One or more of the electrophotographic inks may be a custom or special ink blend. One or more of the electrophotographic inks may be a transparent ink or security taggant ink. In some examples, images comprising multiple colours are printed on the print substrate 107 by sequentially applying differently-coloured electrophotographic inks to the photoimaging drum 102 using different ink developer assemblies 101. For example, after forming the latent electrostatic image on the surface of the photoimaging drum 102, the surface of the photoimaging drum is contacted with a first toner to form a first toner image on the surface of the latent electrostatic image. The first toner image may then be transferred to the print substrate 107 before a second latent electrostatic image is formed on the surface of the photoimaging drum 102. The surface of the photoimaging drum 102 is then contacted with a second toner to form a second toner image on the surface of the second latent electrostatic image. The second toner image is then transferred to the print substrate 107 such that the second toner image is disposed on the first toner image.

In some examples, a plurality of first toner images may be formed, for example different coloured first toner images, and transferred to the print substrate 107 one by one before the second toner image is formed and transferred to the print substrate to be disposed on all of the first toner images.

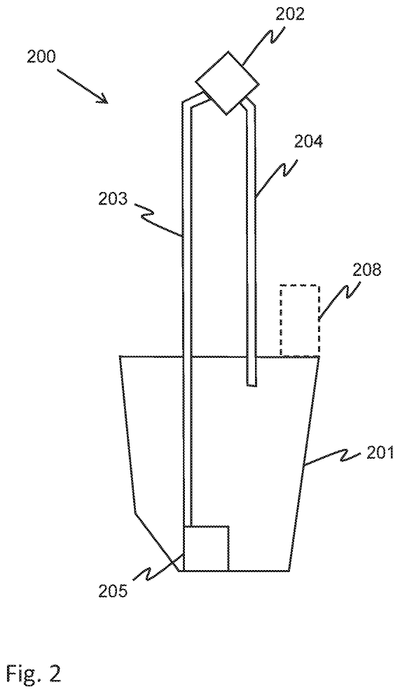

Example upstream ink feed components 200 of a liquid electrophotographic printer are illustrated schematically in FIG. 2. An ink tank 201 is connected to an ink developer assembly 202 by ink conduits 203 and 204. Ink tank 201 houses an ink pump 205 operable to pump ink, in use, from the ink tank 201, through ink conduit 203, to the ink developer assembly 202, and from the ink developer assembly 202, through ink conduit 204, to the ink tank 201. A concentrated ink reservoir 208 may be mounted on a roof of the ink tank 201.

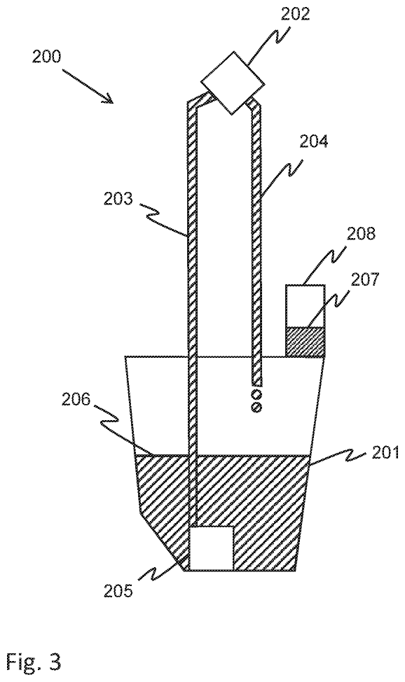

In some examples, a liquid electrophotographic printer is cleaned by flushing cleaning composition through upstream ink feed components. For example, FIG. 3 shows ink tank 201 retaining cleaning composition 206 and pump 205 pumping cleaning composition from the ink tank 201, through the ink conduit 203, through the ink developer assembly 202 and back through the ink conduit 204 into the ink tank 201. Ink residue is removed from the surfaces of the components as they are flushed with the cleaning composition and the ink residue is dispersed into the cleaning composition. Ink residue may therefore be removed from the printer following flushing with the cleaning composition by emptying the ink tank. In this example, the cleaning composition is prepared by diluting a concentrated cleaning composition 207 stored in reservoir 208 with carrier liquid in the ink tank 201. However, in other examples, the diluted cleaning composition 206 may be provided directly in the ink tank.

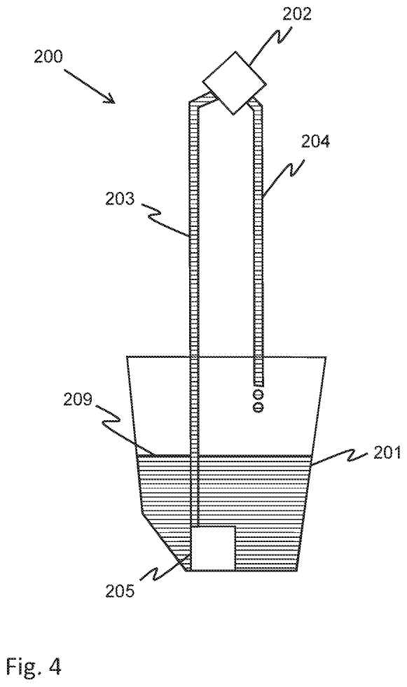

In some examples, cleaning of the liquid electrophotographic printer may include flushing carrier liquid through upstream ink feed components. For example, FIG. 4 shows ink tank 201 retaining carrier liquid 209 and pump 205 pumping carrier liquid from the ink tank 201, through the ink conduit 203, through the ink developer assembly 202 and back through the ink conduit 204 into the ink tank 201. Ink residue may be removed from the surfaces of the components as they are flushed with the carrier liquid. Ink residue may therefore be removed from the printer following flushing with the carrier liquid by emptying the ink tank.

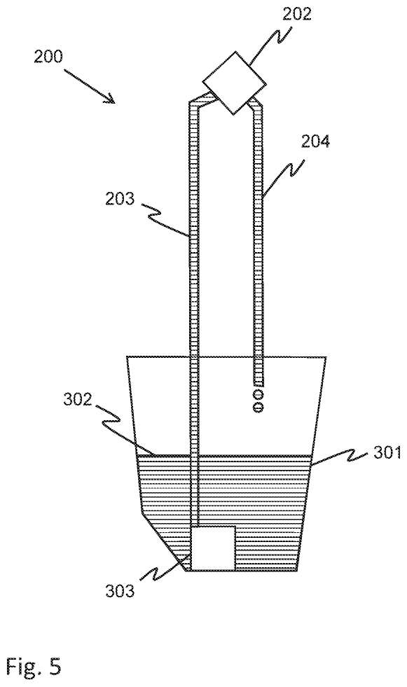

In some examples, cleaning of the liquid electrophotographic printer may include flushing carrier liquid through upstream ink feed components using a flushing tank. For example, FIG. 5 shows a flushing tank 301 connected to the ink developer assembly 202 by ink conduits 203 and 204, replacing ink tank 201. Flushing tank 301 retains carrier liquid 302 and pump 303 pumps carrier liquid from the flushing tank 301, through the ink conduit 203, through the ink developer assembly 202 and back through the ink conduit 204 into the flushing tank 301. Ink residue may be removed from the surfaces of the components as they are flushed with the carrier liquid. Ink residue may therefore be removed from the printer following flushing with the carrier liquid by removing the flushing tank.

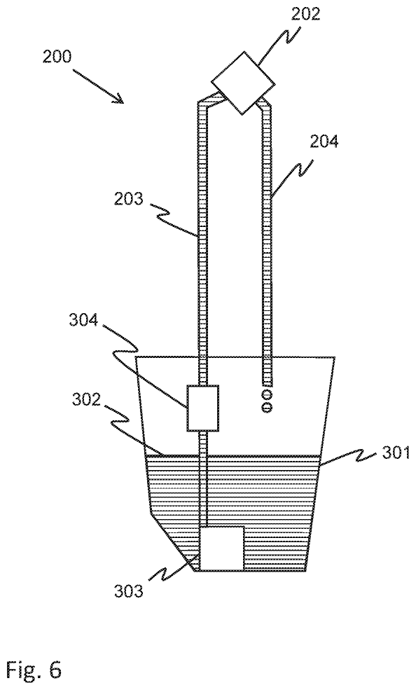

In some examples, cleaning of the liquid electrophotographic printer may include flushing carrier liquid through upstream ink feed components using a flushing tank provided with a filter. For example, FIG. 6 shows the flushing tank 301 connected to the ink developer assembly 202 by ink conduits 203 and 204, replacing ink tank 201. The flushing tank 301 is connected to ink conduit 203 through a filter 304. Flushing tank 301 retains carrier liquid 302 and pump 303 pumps carrier liquid from the flushing tank 301, through the filter 304, through the ink conduit 203, through the ink developer assembly 202 and back through the ink conduit 204 into the flushing tank 301. Ink residue may be removed from the surfaces of the components as they are flushed with the carrier liquid. Ink residue dispersed in the carrier liquid may be trapped by the filter as the carrier liquid is cycled through the system. Ink residue may therefore be removed from the printer following flushing with the carrier liquid by removing the flushing tank and filter.

In some examples, the flushing tank 301 has an alternative configuration in which the filter 304 is located downstream of the ink developer assembly 202 such that pump 303 pumps carrier liquid from the flushing tank 301, through the ink conduit 203, through the ink developer assembly 202, through the ink conduit 204, through the filter 304 and back into the flushing tank 301. In some examples, the flushing tank 301 has an alternative configuration in which the filter is adjacent to, connected to, or integral with the pump 303. The filter may be removable, for example, for cleaning or replacement.

In some examples, the flushing tank is a dedicated flushing tank. The dedicated flushing tank may only be used for flushing upstream ink feed components of the liquid electrophotographic printer with carrier liquid. The dedicated flushing tank may not be used for storing liquid electrophotographic inks and/or for printing. The filter may be integral to the dedicated flushing tank.

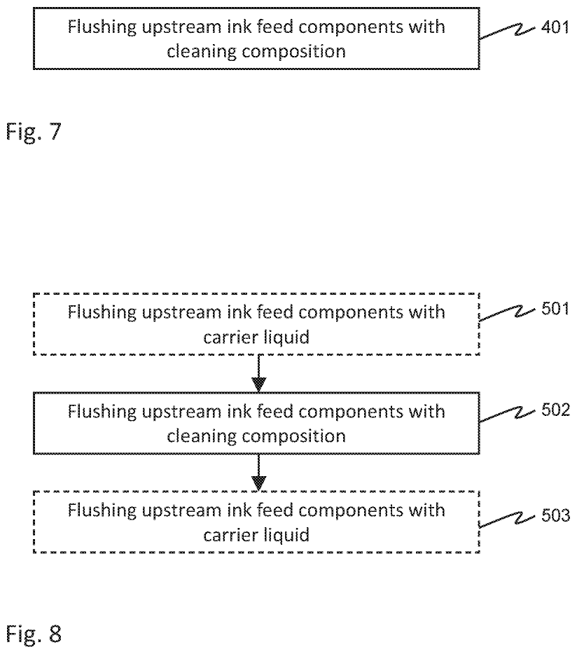

In some examples, a method of cleaning the liquid electrophotographic printer comprises one principal step 401, as shown in FIG. 7, of flushing upstream ink feed component with the cleaning composition, for example, using the apparatus shown in FIG. 3. The upstream ink feed components flushed with the cleaning composition may include the ink tank 201, the ink conduits 203 and 204, and/or the developer assembly 202.

In some examples, a method of cleaning the liquid electrophotographic printer comprises flushing upstream ink feed components with carrier liquid before and/or after flushing upstream ink feed components with cleaning composition. Such an example method is illustrated in the flow diagram of FIG. 8. The method may comprise: block 501 comprising flushing upstream ink feed components with carrier liquid, for example, using the apparatus of FIG. 4, 5 or 6; and subsequent block 502 comprising flushing upstream ink feed components with cleaning composition, for example, using the apparatus of FIG. 3. Alternatively, the method may comprise: block 502 comprising flushing upstream ink feed components with cleaning composition, for example, using the apparatus of FIG. 3; and subsequent block 503 comprising flushing ink feed components with carrier liquid, for example, using the apparatus of FIG. 4, 5 or 6. In a further alternative, the method may comprise: block 501 comprising flushing upstream ink feed components with carrier liquid, for example, using the apparatus of FIG. 4, 5 or 6; subsequent block 502 comprising flushing upstream ink feed components with cleaning composition, for example, using the apparatus of FIG. 3; and subsequent block 503 comprising flushing ink feed components with carrier liquid, for example, using the apparatus of FIG. 4, 5 or 6.

In some examples, a method of cleaning the liquid electrophotographic printer comprises: installing a flushing tank in the liquid electrophotographic printer; flushing upstream ink feed components with carrier liquid using the flushing tank; removing the flushing tank from the liquid electrophotographic printer; installing the ink tank in place of the flushing tank; and flushing upstream ink feed components with cleaning composition using the ink tank. Installing the flushing tank in the liquid electrophotographic printer may be preceded by removing the ink tank from the liquid electrophotographic printer.

In some examples, a method of cleaning the liquid electrophotographic printer comprises: flushing upstream ink feed components with cleaning composition using an ink tank; removing the ink tank from the liquid electrophotographic printer; installing a flushing tank in the place of the ink tank; and flushing upstream ink feed components with carrier liquid using the flushing tank.

In some examples, a method of cleaning the liquid electrophotographic printer comprises: removing an ink tank from the liquid electrophotographic printer; installing a flushing tank in the place of the ink tank; flushing upstream ink feed components with carrier liquid using the flushing tank; removing the flushing tank from the liquid electrophotographic printer; re-installing the ink tank; flushing upstream ink feed components with cleaning composition using the ink tank; removing the ink tank from the liquid electrophotographic printer; installing the flushing tank in the place of the ink tank; and flushing upstream ink feed components with carrier liquid using the flushing tank. The method may further comprise: removing the flushing tank from the liquid electrophotographic printer; and re-installing the ink tank.

In some examples, a method of cleaning the liquid electrophotographic printer comprises: removing an ink tank from the liquid electrophotographic printer; washing an interior of the ink tank with carrier liquid; installing a flushing tank in the place of the ink tank; flushing upstream ink feed components with carrier liquid using the flushing tank; removing the flushing tank from the liquid electrophotographic printer; re-installing the ink tank; flushing upstream ink feed components with cleaning composition using the ink tank; removing the ink tank from the liquid electrophotographic printer; washing the interior of the ink tank with carrier liquid; installing the flushing tank in the place of the ink tank; and flushing upstream ink feed components with carrier liquid using the flushing tank. The method may further comprise: removing the flushing tank from the liquid electrophotographic printer; and re-installing the ink tank.

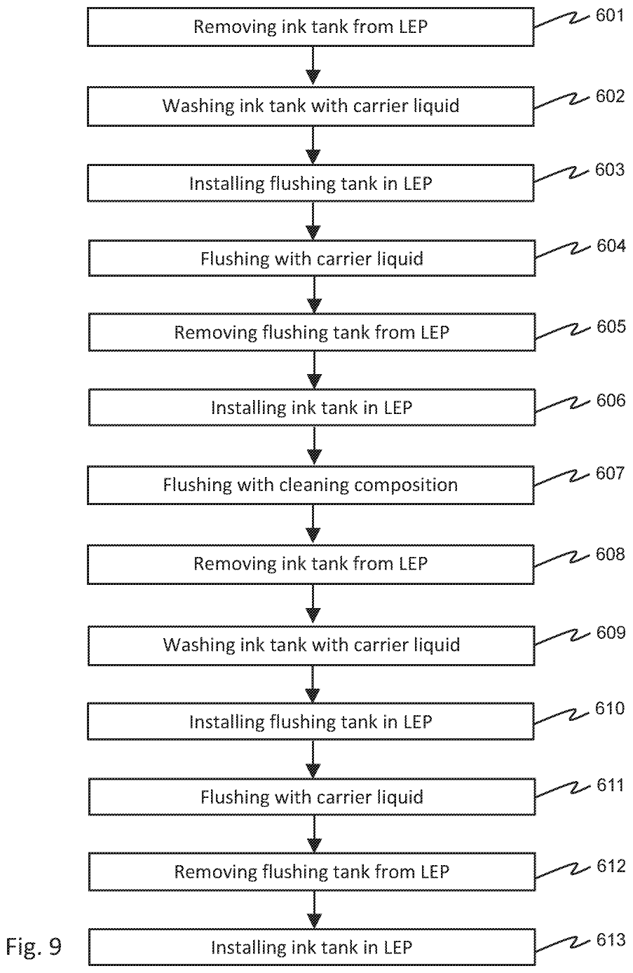

A further example method of cleaning the liquid electrophotographic printer is illustrated as a flow diagram in FIG. 9. Block 601 comprises removing an ink tank from the liquid electrophotographic printer. Block 602 comprises washing the ink tank with carrier liquid. Block 603 comprises installing a flushing tank in place of the ink tank. Block 604 comprises flushing upstream ink feed components with carrier liquid using the flushing tank. Block 605 comprises removing the flushing tank. Block 606 comprises re-installing the ink tank in place of the flushing tank. Block 607 comprises flushing upstream ink feed components with cleaning composition using the ink tank. Block 608 comprises removing the ink tank. Block 609 comprises washing the ink tank with carrier liquid. Block 610 comprises installing a flushing tank in place of the ink tank. Block 611 comprises flushing upstream ink feed components with carrier liquid using the flushing tank. Block 612 comprises removing the flushing tank. Block 613 comprises re-installing the ink tank in place of the flushing tank.

It will be appreciated that the steps of any methods discloses herein may be varied.

The ink tank may be washed with carrier liquid prior to, during, or after installing the flushing tank in the liquid electrophotographic printer.

The method may comprise emptying a majority of ink from the ink tank prior to washing the ink tank. The method may comprise filling the ink tank with cleaning composition prior to or after installation in the liquid electrophotographic printer. The method may comprise filling the ink tank with ink prior to or after re-installing the ink tank in the liquid electrophotographic printer following cleaning. The method may comprise washing the ink tank with carrier liquid prior to filling the ink tank with ink.

The method may comprise filling the flushing tank with carrier liquid prior to or after installation in the liquid electrophotographic printer. The method may comprise emptying a majority of carrier liquid from the flushing tank after removing the flushing tank from the liquid electrophotographic printer.

The method may comprise emptying a majority of a first ink from the ink tank prior to cleaning and filling the ink tank with a second ink after cleaning. The method may comprise emptying a majority of a first ink from the ink tank prior to cleaning and refilling the ink tank with the first ink after cleaning.

Washing the ink tank with carrier liquid may comprise washing an interior of the ink tank with carrier liquid. Washing the ink tank with carrier liquid may comprise flushing an interior of the ink tank with carrier liquid. Washing the ink tank with carrier liquid may comprise washing the interior of the ink tank with carrier liquid using a cleaning tool, for example, a brush.

In some examples, the method comprises using more than one ink tank and/or more than one flushing tank. For example, the method may comprise: removing a first ink tank from the liquid electrophotographic printer; cleaning upstream ink feed components of the liquid electrophotographic printer used any other method described herein; and installing a second ink tank into the liquid electrophotographic printer in place of the first ink tank. In some examples, the method may comprise: pumping carrier liquid from a first flushing tank through upstream ink feed components; pumping cleaning composition from an ink tank through upstream ink feed components; and pumping carrier liquid from a second flushing tank through upstream ink feed components.

One or more of the steps of the method may be carried out manually. The method may comprise manually removing and/or installing the ink tank and/or the flushing tank. The method may comprise manually washing the ink tank with carrier liquid. The method may comprise manually filling the ink tank and/or the flushing tank with carrier liquid and/or cleaning composition and/or ink.

One or more of the steps of the method may be carried out automatically, that is to say, one or more steps of the method may be automated. The method may comprise automatically removing and/or installing the ink tank and/or the flushing tank. The method may comprise automatically washing the ink tank with carrier liquid. The method may comprise automatically filling the ink tank and/or the flushing tank with carrier liquid and/or cleaning composition and/or ink.

The liquid electrophotographic printer may be configured to carry out one or more of the steps of the method automatically. The liquid electrophotographic printer may comprise, or be in electronic communication with, a controller, such as a processor, configured or programmed to carry out one or more of the steps of the method. The controller or processor may be in electronic communication with a memory storing computer executable program code comprising instructions which, when executed, cause the liquid electrophotographic printer to carry out one or more steps of the method.

### EXAMPLES

The following illustrates examples of the materials, methods and related aspects described herein. Thus, these examples should not be considered as restricting the present disclosure, but are merely in place to teach how to make examples of the present disclosure. As such, a representative number of compositions and their method of manufacture are disclosed herein.

Materials

Resins

Nucrel® 699 (available from DuPont): a copolymer of ethylene and methacrylic acid, made with nominally 11 wt. % methacrylic acid.

AC-5120 (available from Honeywell): ethylene-acrylic acid copolymer with an acrylic acid content of 15 wt. % and an acid number of 112-130 KOH/g.

Carrier Liquid

Isopar L (available from EXXON): an isoparaffinic oil.

Charge Adjuvant and Grinding Agent

VCA (available from Sigma-Aldrich): an aluminium stearate.

Charge Director

NCD: a natural charge director having the components (i) natural soya lecithin, (ii) Basic Barium Petronate®, and (iii) dodecyl benzene sulfonic acid, amine salt, with the components (i), (ii) and (iii) being present in the weight ratios of 6.6%:9.8%:3.6%.

Basic Barium Petronate®: oil-soluble petroleum sulfonate.

Composition

A resin paste was formed by mixing the resins Nucrel 699 and AC-5120 together in a ratio of 4:1 at 25 wt. % NVS in the presence of Isopar L carrier liquid in a Ross mixer (Model DOPM-2, obtained from Charles Ross & Son Company—Hauppauge N.Y.) at 120-150° C. and 50 rpm for 90 min, and then the RPM was raised to 70 for 120 min. Subsequently, the temperature was lowered to room temperature and, after 30 min, the RPM was lowered to 50 to obtain the resin paste. 34.7 kg of the resin paste was combined with 0.123 kg of VCA adjuvant and 20.17 kg Isopar L before grinding (at 245 rpm and 25° C.) for 24 hours. The composition was then concentrated by vacuum Nutsche filter, such as a Büchner Funnel, to 20 wt. % NVS. NCD (at 1.5 mg per 1 g of solids) and Basic Barium Petronate® (at 9.6 mg per 1 g of solids) were added to the 20 wt. % NVS concentrated cleaning composition.

The final cleaning composition was prepared by diluting 560 g of the concentrated cleaning composition with 2.9 kg of Isopar L to 3.2 wt. % NVS.

Test

The cleaning composition was used to clean ink tanks and upstream ink feed components of an HP Indigo LEP press.

Method

An ink tank was removed from the press and emptied of a first liquid electrophotographic ink. The ink tank was washed manually using Isopar L.

A flushing tank was installed in the LEP press in place of the removed ink tank. The flushing tank was filled with 4 litres of Isopar L. Isopar L was pumped from the flushing tank, through connecting tubes, through the ink developer assembly and through a filter, using the HP On-press Fast Ink Replacement (OFIR) method. This first flushing process lasted 20 minutes.

The flushing tank was removed from the LEP press. The ink tank was installed in the LEP press in place of the removed flushing tank. The ink tank was filled with cleaning composition (i.e. diluted cleaning composition comprising 560 g of concentrated cleaning composition and 2.9 kg of Isopar L). The cleaning composition was pumped from the ink tank, through connecting tubes and through the ink developer assembly. This second flushing process lasted 20 minutes.

The ink tank was removed from the LEP press and emptied of cleaning composition. The ink tank was washed manually using Isopar L.

The flushing tank was installed in the LEP press in place of the removed ink tank. The flushing tank was filled with 4 litres of Isopar L. Isopar L was pumped from the flushing tank, through connecting tubes, through the ink developer assembly and through the filter, using the HP On-press Fast Ink Replacement (OFIR) method. This third flushing process lasted 20 minutes.

The flushing tank was removed from the LEP press. The ink tank was installed in the LEP press in place of the removed flushing tank. The ink tank was filled with a second liquid electrophotographic ink.

The LEP press was used to print the second ink onto a substrate and the printed ink was examined for contamination with the first ink, both visually and using CIE LAB testing.

Results

Seven tests were carried out using the first and second HP Indigo Electrolnk® liquid electrophotographic inks as set out in Table 1.

TABLE 1

| Test | First Ink | Second Ink | Result |
|---|---|---|---|
| 1 | Magenta | Transparent | No Contamination |
| 2 | Green | Transparent | No Contamination |
| 3 | Violet | Transparent | No Contamination |
| 4 | Black/Magenta | Transparent | No Contamination |
| 5 | Magenta | Ultra-Violet Red | No Contamination |
| 6 | Silver | Security Taggant | No Contamination |
| 7 | Magenta | Transparent Primer | No Contamination |

In each test, no visible contamination of the second ink with the corresponding first ink was observed. On further inspection, no residue of the first ink was found in the cleaned ink developer assembly.

1. A method of cleaning a liquid electrophotographic printer (LEP), the method comprising flushing upstream ink feed components of the liquid electrophotographic printer with a cleaning composition comprising a resin and a charge director dispersed in a carrier liquid;
wherein the cleaning composition comprises from about 3 wt. % to about 6 wt. % non-volatile solids (NVS).

2. The method according to claim 1 comprising flushing upstream ink feed components with carrier liquid before and/or after flushing upstream ink feed components with the cleaning composition.

3. The method according to claim 1 comprising:
pumping carrier liquid from a flushing tank through upstream ink feed components of the LEP;
pumping cleaning composition from an ink tank through upstream ink feed components of the LEP; and
pumping carrier liquid from a flushing tank through upstream ink feed components of the LEP.

4. The method according to claim 3 comprising:
removing an ink tank from the LEP;
installing a flushing tank in the LEP, pumping carrier liquid from the flushing tank through upstream ink feed components of the LEP, and removing the flushing tank from the LEP;
installing the ink tank in the LEP, pumping cleaning composition from the ink tank through upstream ink feed components of the LEP, removing the ink tank from the LEP;
installing a flushing tank in the LEP, pumping carrier liquid from the flushing tank through upstream ink feed components of the LEP, and removing the flushing tank from the LEP; and
installing the ink tank in the LEP.

5. The method according to claim 4 comprising:
emptying the ink tank of a first liquid electrophotographic ink prior to cleaning the upstream ink feed components; and
filling the ink tank with a second liquid electrophotographic ink after cleaning the upstream ink feed components.

6. The method according to claim 4, wherein pumping carrier liquid from the flushing tank through upstream ink feed components of the LEP further comprises filtering the carrier liquid to remove ink residue therefrom.

7. The method according to claim 1, wherein upstream ink feed components comprise one or more of the following: ink tanks, ink conduits, ink pumps, ink developer assemblies.

8. The method according to claim 1, wherein the charge director is an oil-soluble petroleum sulfonate in an amount of at least about 0.5 wt. % of the solids in the cleaning composition.

9. A liquid electrophotographic printer cleaning composition comprising:
a carrier liquid;
a resin;
and a charge director;
wherein the LEP cleaning composition comprises from about 3 wt. % to about 6 wt. % non-volatile solids (NVS).

10. The LEP cleaning composition according to claim 9, wherein the cleaning composition is transparent.

11. The LEP cleaning composition according to claim 9, wherein the charge director constitutes at least about 5 mg per 1 g of the solids in the LEP cleaning composition.

12. The LEP cleaning composition according to claim 9, wherein the charge director is an oil-soluble petroleum sulfonate in an amount of at least about 5 mg per 1 g of the solids in the LEP cleaning composition.

13. The LEP cleaning composition according to claim 12 further comprising a natural charge director (NCD).

14. The LEP cleaning composition according to claim 9 comprising a charge adjuvant.

15. The LEP cleaning composition according to claim 9, wherein the resin comprises ethylene methacrylic acid copolymer and/or ethylene acrylic acid copolymer and the carrier liquid is a paraffinic or isoparaffinic compound.
